(19) United States
(12) Patent Application Publication
(10) Pub. No.: US 2018/0353845 A1
(43) Pub. Date: Dec. 13, 2018

(54) Laser Tag Sword System and Method of Use

(71) Applicant: Laser Tag Pro, Inc., Greenfield, WI (US)

(72) Inventors: Aaron Fischer, Greenfield, WI (US); Zachary Dickerson, Greenfield, WI (US)

(73) Assignee: Laser Tag Pro, Inc., Greenfield, WI (US)

(21) Appl. No.: 16/105,833

(22) Filed: Aug. 20, 2018

Related U.S. Application Data
(63) Continuation-in-part of application No. 15/396,464, filed on Dec. 31, 2016.
(60) Provisional application No. 62/547,138, filed on Aug. 18, 2017.

(51) Int. Cl. A63F 9/24; G06K 19/07; G06K 7/10

(52) U.S. Cl. CPC A63F 9/24; G06K 19/0723; G06K 7/10386; A63F 2009/2444; A63F 2250/10; A63F 2009/2454; A63F 2009/2477; A63F 2009/2489; A63F 2009/2447

(57) ABSTRACT

A computerized method for operation of laser tag melee weapons is disclosed. The laser tag melee weapons contain infrared emitters, infrared receivers, microprocessors, accelerometers, and gyroscopes. The operation of the infrared emitter is based upon a pattern of signals received by the microprocessor from the accelerometer and gyroscope. The method is also directed toward altering game play information (such as user health, weapon status, power ups, or other game information) based on a pattern of signals received by the microprocessor from the accelerometer and gyroscope. When a user makes a specific movement pattern of the laser tag melee weapon, the microprocessors recognize the specific movement based on patterns of signals received. The microprocessors also compare signals received from the accelerometer and gyroscope to hit signals received from infrared receivers to determine if a user should be “hit” in the game.

### PRIORITY

This application is a continuation-in-part of U.S. application Ser. No. 15/396,464, filed on December 31, 2016, the disclosure of which is hereby fully incorporated by reference. This application also claims priority to U.S. Provisional Patent Application Ser. No. 62/547,138, filed on Aug. 18, 2017, the disclosure of which is hereby fully incorporated by reference.

### FIELD OF THE INVENTION

This invention pertains generally to laser tag gaming systems and more particularly to a laser tag sword, a receiving vest, and a method of use.

### BACKGROUND OF INVENTION

Laser tag is a very popular game and is known in the prior art. Historically, a laser tag system has utilized multiple firearm-like devices or “guns”. The guns incorporate an infrared emitter and an infrared receptor. The infrared receptor may be incorporated into the gun or within a separate device connected to the gun through a wire or wireless means. Normally the infrared receptor is worn as a separate device on a player's chest or arm. A player aims his gun at another player and pulls the trigger. The trigger activates the infrared emitter on the gun. The infrared signal travels toward the infrared receptor worn by the other player. If the infrared signal activates the infrared receptor then a signaling means is activated. The signaling means is intended to inform the player that the player has been “hit.” The signaling means is normally a vibration, a flashing light, or an audible sound. Optionally, a player's gun may become deactivated when the player is hit.

Historically laser tag systems have solely utilized gun type emitters. The emitters are gun shaped and have a trigger which a user must pull to engage the emitter. These type of emitters provide a single type of game play—the player pretends to shoot a gun. What is needed is an additional type of weaponry which may be utilized in laser tag game play permitting an expansion on the type of game play and interaction between the players.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a computerized method for operation of laser tag melee weapons. The laser tag melee weapons contain infrared emitters, infrared receivers, microprocessors, accelerometers, and gyroscopes. The inventive method is directed toward controlling the operation of the infrared emitter based upon a pattern of signals received by the microprocessor from the accelerometer and gyroscope. The method is also directed toward altering game play information (such as user health, weapon status, power ups, or other game information) based on a pattern of signals received by the microprocessor from the accelerometer and gyroscope.

The method is also directed toward comparing signals received from the accelerometer and gyroscope to hit signals received from infrared receivers to determine if a user should be “hit” in the game.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic view of a laser tag sword;

FIG. 2 is a schematic front view of a laser tag sword, vest, and headset combination system being worn by a user;

FIG. 3 is a schematic rear view thereof;

FIG. 4 is a schematic view of a user holding a laser tag sword;

FIG. 5 is a schematic view of a user swinging a laser tag sword;

FIG. 6 is a schematic view of the movement of a laser tag sword in three dimensional space;

FIG. 7 is a graph of movement of the laser tag sword along the Y-axis;

FIG. 8 is a graph of movement of the laser tag sword along the X-axis;

FIG. 9 is a graph of movement of the laser tag sword along the Z-axis;

FIG. 10 is a graph of acceleration of the laser tag sword;

FIG. 11 is a graph of acceleration of the laser tag sword;

FIG. 12 is a graph of acceleration of the laser tag sword;

FIG. 13 is a graph of acceleration of the laser tag sword;

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

The invention is directed toward a laser tag sword or other melee weapon. The sword is fitted with IR emitters that emit up the blade when impact is made with any object based on the gyroscope and accelerometer readings. The IR signal goes up the blade making contact with IR receivers worn on player's bodies. This could be on head, body, legs, or all. If the person hit with the IR signal does not have made contact close to the same time they received the signal they take damage. If both players hit blades and both vest receive signals with in a very short period of time the vests communicate as such to each other and no damage is done to either player. Players who take damage can have LEDs flash and play sounds to signal to the other player that they successfully scored. The speaker will also play all attacking sounds and special sounds related to the game.

A software application can be paired to the vest. Through a wireless signal the application can measure live scoring, provide level up capabilities to players, provide power up capabilities to weapons or armor, create special attacks (fire, ice, poison damage), or cause a critical blow. Players may also utilize shields that send and receive signals. The system may be utilized with any number of players.

The laser tag sword can be fashioned into all kinds of foam and plastic weapon types: swords, mallets, staffs, axes etc. The laser tag sword may be communicatively coupled to one or more vests or head bands worn by one or more players.

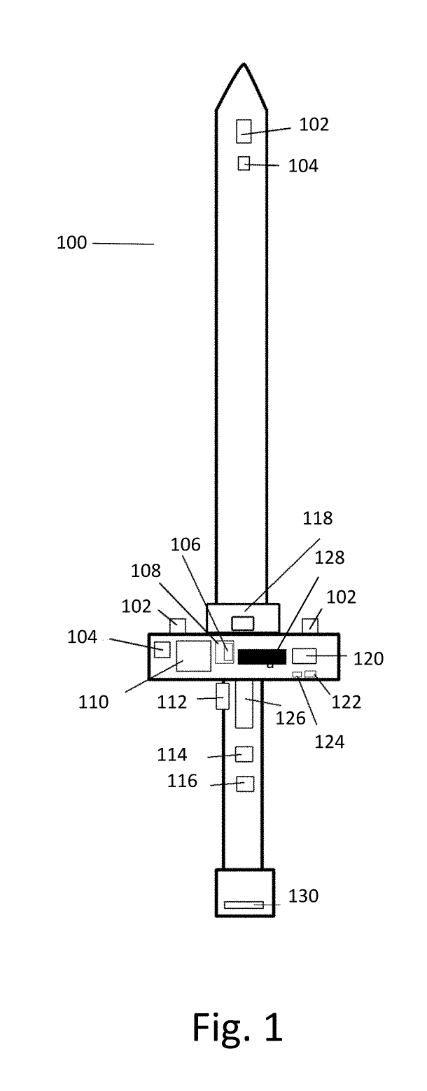

Referring to FIG. 1, the preferred embodiment of the laser tag sword 100 is illustrated. As seen in FIG. 1, the laser tag sword 100 is a shaped gaming implement which has a sword design. The laser tag sword 100 may have any shape and design. In other embodiments the laser tag sword 100 is a circular rod without sword design elements. In its simplest form, the laser tag sword 100 is an elongate member with any shaped cross-section (circular or polyhedron) that allows a user to hold one end of the member and position the opposite end of the member in a desired location in space. In the preferred embodiment the laser tag sword 100 has a plurality of infrared emitters 102 and a plurality of omnidirectional infrared receivers 104. These infrared emitters 102 and receivers 104 may be placed on any position on the laser tag sword 100. The laser tag sword 100 has an internal battery 126 to power the operations of the laser tag sword 100 and a microcontroller 110 for controlling the functionality and gaming function of the laser tag sword 100. The laser tag sword 100 may have a power switch 124 to allow a user to turn the device on and off. The laser tag sword 100 may also have a charging port 122 to charge the battery 126 of the laser tag sword 100 when not in use.

The laser tag sword 100 may have a keypad 112 for receiving user input information. The laser tag sword 100 may have an LCD screen 128 to display game related information. The LCD screen 128 may also be touch sensitive to allow a user to input information through touching icons on the LCD screen 128. The laser tag sword 100 may have one or more LEDs which enlighten while the laser tag sword 100 is in use. The LEDs may be any color and may change color when a change in game status occurs such as signifying a hit. The laser tag sword 100 may also have a speaker 130 which plays sounds and may emit sound when a change in game status occurs such as signifying a hit.

The laser tag sword 100 may have one or more communications components allowing the laser tag sword 100 to send and receive information with the gaming system. This may include a transceiver, a Bluetooth radio component 120, a near field communication component 116, and an RFID chip 114.

The laser tag sword 100 has an accelerometer 106 and a gyroscope 108 within the body of the laser tag sword 100. The accelerometer 106 measures when the laser tag sword 100 is being swung and when it may come to an abrupt stop. The gyroscope 108 measures the position of the sword in space and can determine if the laser tag sword 100 is in a vertical position, horizontal position, inclined angle or any other oriented position in space.

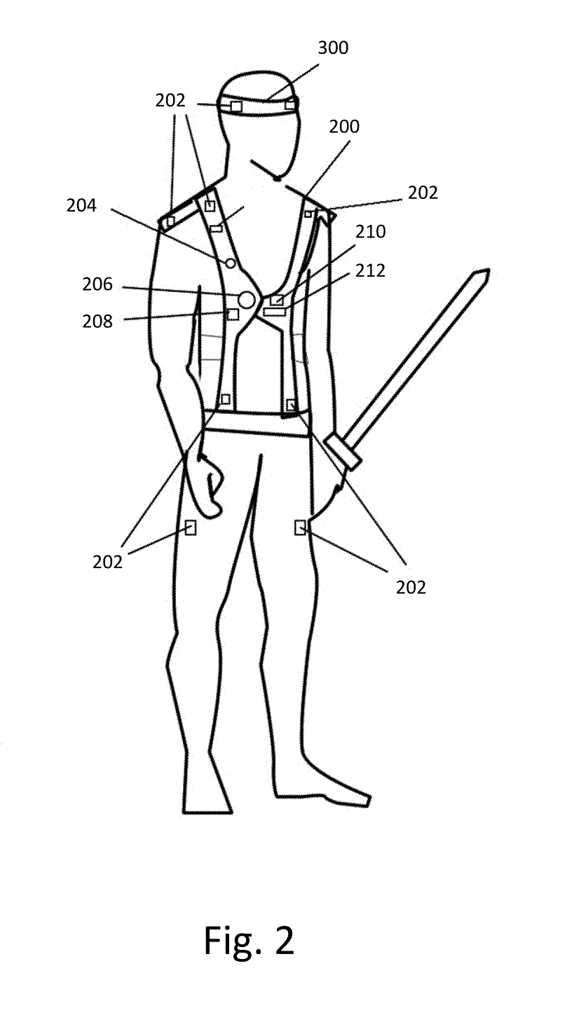

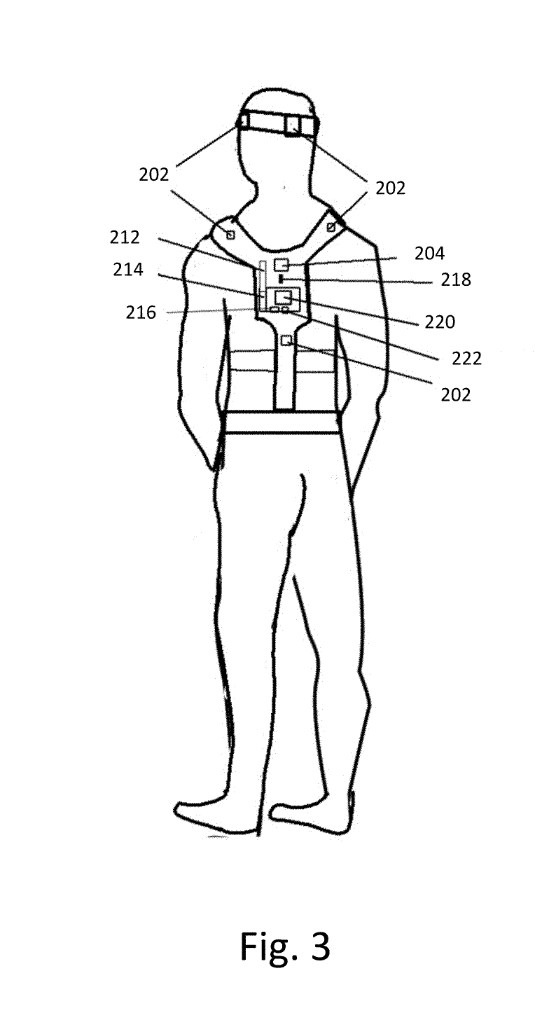

Referring to FIG. 2, a user is shown with a laser tag sword 100 in combination with a gaming vest 200 and headset 300. The laser tag sword 100 may be utilized alone or in combination with a gaming vest 200, a gaming headset 300, or both simultaneously. The gaming vest 200 and headset have a plurality of omnidirectional infrared receivers 202 for detecting infrared beams emitted by the laser tag sword 100. The gaming vest 200 and gaming headset 300 may also have infrared emitters 204 in some embodiments. The gaming vest 200 and gaming headset 300 may have a keypad 210 and LCD screen 212 for receiving and displaying game information. The gaming vest 200 and gaming headset 300 may have one or more speakers 206 and one or more LEDs 218 to signify a hit or other change in gameplay. The gaming vest 200 and gaming headset 300 may each have their own microcontroller 220 for controlling the functionality of the devices during game play. The gaming vest 200 and gaming headset 300 may each have a battery 214, charging port 216, and power switch 222. The gaming vest 200 and gaming headset 300 may each have a Bluetooth radio 208, transceiver 212, antenna, or other wireless communication means.

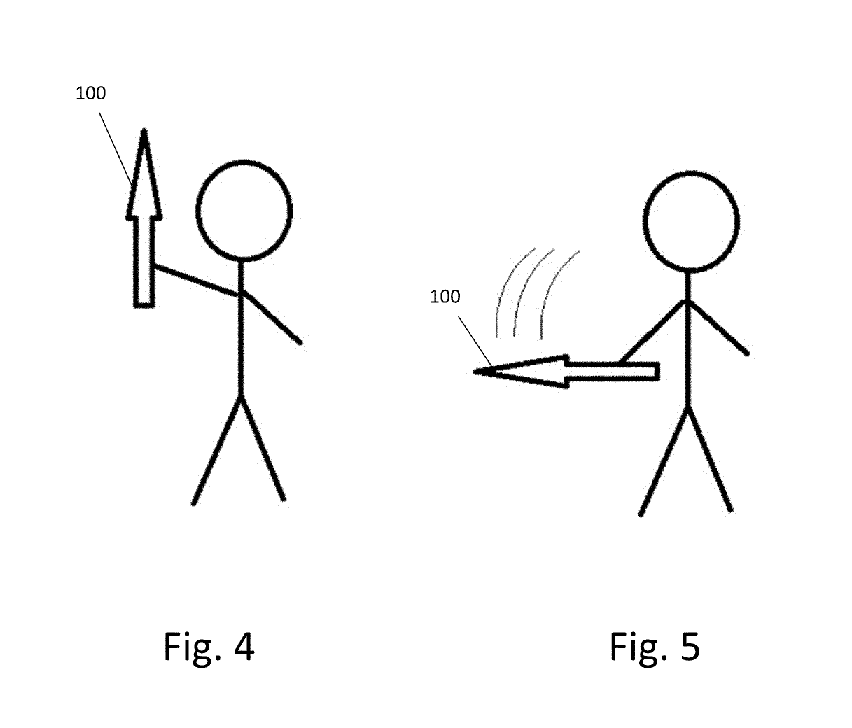

The operation of the laser tag sword 100 during gameplay allows the user to engage in competitors as they would in standard laser tag games but with the use of a melee weapon. The laser tag sword 100 operates in a manner that when a user swings the laser tag sword 100, the movement activates the accelerometer 106 and/or gyroscope 108. When either the accelerometer 106 or the gyroscope 108 are activated each one may send a signal to the microcontroller. The microcontroller registers the activation and determines the movement made by the user. When the microcontroller determines that either has been activated the microcontroller then sends a signal to activate the one or more infrared emitters. The laser tag sword 100 then emits an infrared beam. An opposing player may “hit” by the infrared beam when an infrared receiver worn by the other user or in the other user's laser tag sword 100 detects the emitted beam. This hitting is illustrated in FIG. 4 and FIG. 5. In FIG. 4, the user holds the laser tag sword 100 in a vertical orientation. Then, as shown in FIG. 5, the user swings the laser tag sword 100 down into a horizontal orientation. The swinging of the laser tag sword 100 activates the gyroscope 108 and accelerometer 106 in the laser tag sword. When the gyroscope 108 and accelerometer 106 are activated they send signals to the microcontroller 110. When the microcontroller 110 determines that the signals are above a predetermined threshold, the microcontroller 110 activates the infrared emitter 102.

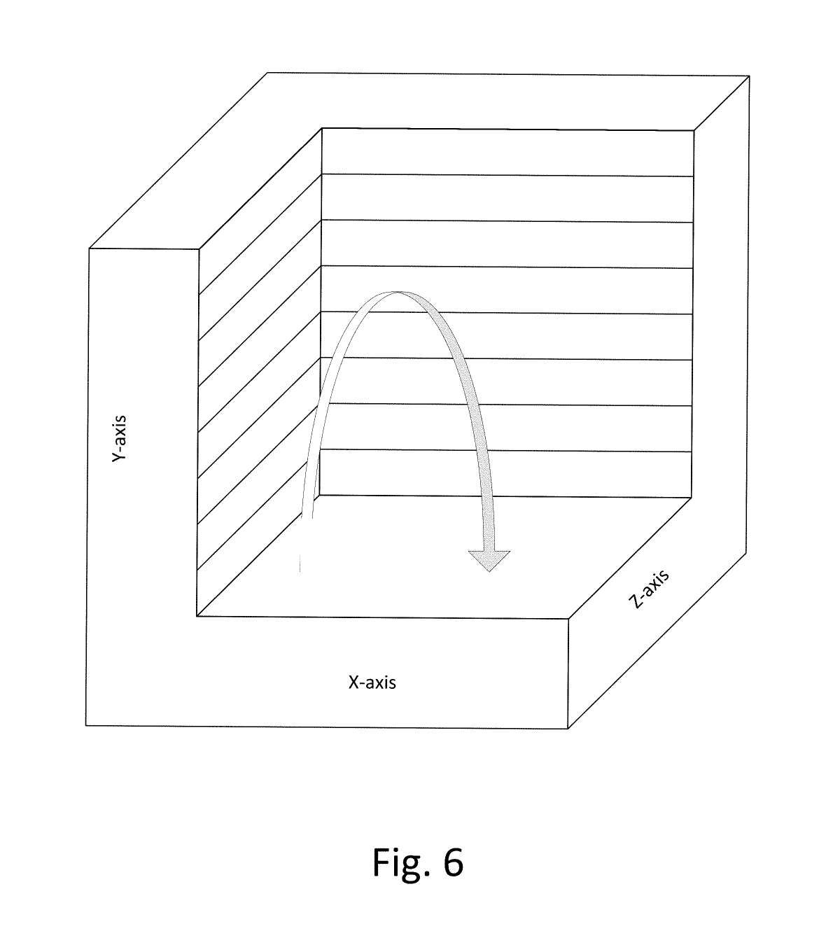

The operation of the microcontroller 110 in combination with the accelerometer 106 and gyroscope 108 is illustrated in FIG. 6 through FIG. 13. As shown in FIG. 6, the movement of the laser tag sword 100 through three dimensional space is illustrated. This movement is measured by the combination of accelerometer 106 and gyroscope 108 (or multiple accelerometers 106 and multiple gyroscopes 108). In the example illustrated in FIG. 6, the laser tag sword moves along an x, y, and z axis. Any plane in space may be defined by each of the x, y, and z axes. In this illustration, the laser tag sword moves upward and downward along the y-axis, straight along the x-axis, and straight along the z-axis.

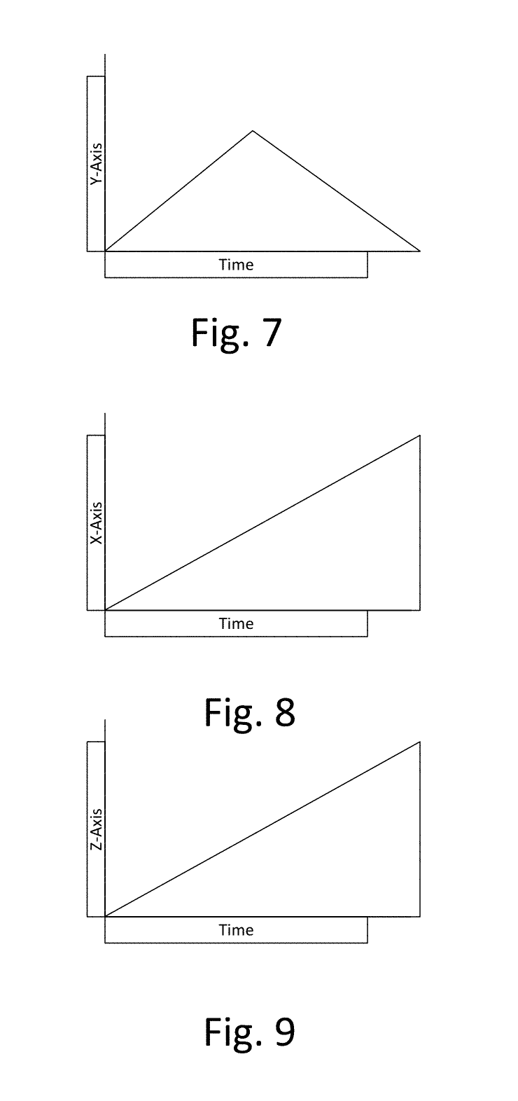

The movement as measured along these axes by the accelerometer 106 and gyroscope 108 are measured along each independent axis to determine the motion of the laser tag sword 100 through space. As shown in FIG. 7, the laser tag sword moves upward along the y-axis until it reaches a peak and then moves downward. FIG. 8 shows the motion of the laser tag sword 100 along the x-axis. In this illustration, the laser tag sword 100 moves in a constant motion along the x-axis. FIG. 9 shows the motion of the laser tag sword along the z-axis. In this illustration, the laser tag sword 100 moves in a constant motion along the x-axis. From the information detected from the accelerometer 106 and gyroscope 108, the microprocessor 110 can determine the motion and position of the laser tag sword 100 in three dimensional space.

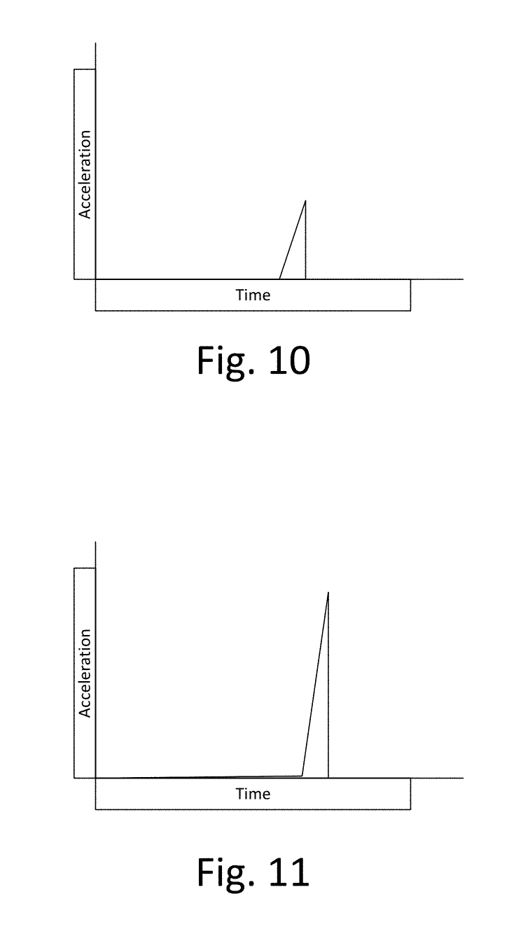

The microprocessor 110 is also configured to control the emissions of the infrared emitter 102 based on signals received from the accelerometer 106. FIG. 10 through FIG. 13 illustrate signals which could be received from the accelerometer 106. As shown in FIG. 10, the accelerometer 106 measures a small acceleration followed by a small deceleration. This would occur when the user swings the laser tag sword 100 at a certain speed and abruptly stops it (for instance when hitting another user). FIG. 11 illustrates the accelerometer 106 measuring a larger acceleration followed by a large deceleration. This would happen if the user performs the same movement with greater force (such as with a greater speed of swinging). The microprocessor 110 may be configured to recognize the amount of acceleration and deceleration and encode the infrared beam with information relevant to the amount of damage that the swing would cause. For instance, because FIG. 11 shows a greater acceleration and deceleration than FIG. 10, the microprocessor 110 could encode the infrared beam with information that the user who is hit by the swing should lose more game health. In other embodiments the information may be transmitted by the transceiver of the laser tag sword 100.

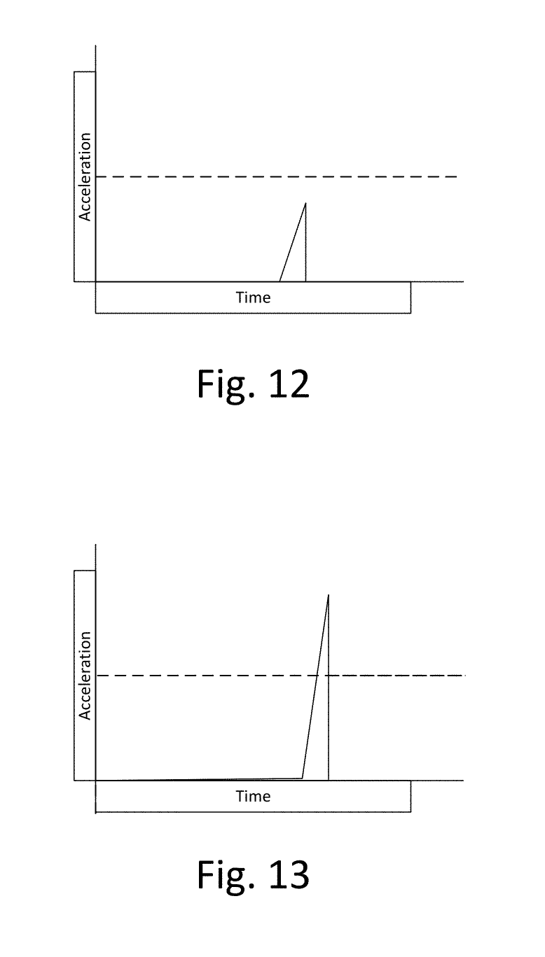

The microprocessor 110 may also be utilized to regulate the output of the infrared emitter 102 based on readings from the accelerometer 106, as shown in FIG. 12 and FIG. 13. As shown in FIG. 12 and FIG. 13, there is a predetermined threshold established by the microprocessor 110. If the accelerometer 106 detects a force greater than the threshold level, then the microprocessor 110 activates the infrared emitter 106. If the force detected by the accelerometer 106 is not above the predetermined threshold, then the microprocessor 110 does not activate the infrared emitter 102. As shown in FIG. 12, the accelerometer 106 detects a small force of acceleration and deceleration. This level does not reach the predetermined threshold set by the microprocessor 110. Therefore, the microprocessor 110 does not activate the infrared emitter 102. As shown by FIG. 13, the force detected by the accelerometer 106 exceeds the predetermined threshold. The microprocessor 110 determines that the force exceeds the predetermined threshold and activates the infrared emitter 102.

Game play can be controlled and managed by the microcontrollers to make gameplay more nuanced and interactive. The specification will explain with the microcontroller 110 for the laser tag sword 100 as performing the operations. However, one skilled in the art would recognize that the microcontroller 220 on the gaming vest 200 or in the gaming headset 300 could also perform the operations herein. For instance, the microcontroller 110 may determine a hit when there is an abrupt stop detected by the accelerometer 106 in the laser tag sword 100. The gameplay may determine that the opposing player receives more damage when the force of the abrupt stop detected by the accelerometer 106 is greater. The system may also compare the player's sword activity to the sword activity of an opposing player to determine the appropriate action in the game play. For instance, if two players each swing their laser tag sword 100 and hit each other then the accelerometer 106 in each sword detects an abrupt stop. The microcontroller 110 then sends a wireless signal to the laser tag sword 100 of the opposing player. The microcontrollers 110 determine that both players have scored a hit and therefore neither player takes game damage. Alternatively, the system may be configured that each player has taken less damage than if a single hit were detected.

In other embodiments the infrared receivers 202 placed on the gaming vest 200 and gaming headset 300 may independently receive an infrared signal to determine a hit. In this way, a user may receive more game health damage if the hit is on the head than on a location on the gaming vest 200. The system may be configured that certain receivers on the gaming vest 200 cause more game health damage when hit than others. For instance, a gaming vest 200 may have a receiver placed over the heart of the user. If a player receives a hit with this receiver then the player may receive more game health damage than if a hit is detected with a different receiver on the gaming vest 200.

In other embodiments the laser tag sword 100 may receive power ups during game play for a short period of time. In other embodiments the system may be configured such that the laser tag sword 100 may be leveled up and be able to do greater damage than other swords in game play.

In other embodiments a player may be able to block strikes by the opposing player. For instance, if a user holds the laser tag sword 100 in an inverted position then the gyroscope 108 determines the laser sword is in an inverted position and thus is able to block hits from other users. In other embodiments of game play the user may have to hold the laser tag sword 100 in a specific position for a predetermined period of time in order to receive a power up, such as extra game health or extra weapon damage. The microcontroller 110 determines that the laser tag sword 100 is held in a still and consistent position by signals received by the gyroscope 108. When the sword has been held in the position for the predetermined period of time then the player receives the game power up.

In some embodiments the infrared signal emitted by the laser tag sword 100 may be encoded with a signal containing gameplay information, such as the identity of the user or the type of weapon being utilized. The infrared signal may be encoded by having a pulsing pattern or may contain certain frequencies of light. The receivers of the other player may detect the pulses or frequencies and make changes to game play according to the received signal.

In other embodiments the laser tag sword 100 may be configured to be an axe, a dagger, a longsword, a club, a mace, a staff, or any other handheld melee weapon. The laser tag sword 100 may be a single-handed weapon or may be two-handed weapon.

In other embodiments the gaming vest 200 or gaming headset 300 has pads which detect physical hits from the laser tag sword 100. When a pad receives a physical hit the pad then sends a signal to the microcontroller 220 and the player is hit and receives game damage.

In other embodiments the user utilizing a laser tag sword 100 may use a shield (not shown) containing one or more omnidirectional receivers. The shield may have a limited number of strikes that is protects from. For instance, the shield may block only four strikes by another player. The shield may be communicatively coupled to the gaming vest 200 and gaming headset 300 of the user so that if both the shield and the vest receive a hit, and the shield is still operative, then the player receives no game damage.

In other embodiments the laser tag sword 100 may only emit an infrared beam from the infrared emitter 102 is the user moves the laser tag sword 100 in a specific motion, such as in a vertical circular motion. Other specific movements may be utilized to control the infrared emitter 102 and changes in game play caused by the specific motions. For instance, if a laser tag sword is swung horizontally ninety degrees, pointed upward, pointed downward, and then swung upward, the readings from the accelerometers 106 and gyroscopes 108 would generate a specific pattern of signals which would be received by the microprocessor 110. The microprocessor 110 would determine when this specific pattern of signals is generated from the separate components and (1) send a signal to the infrared emitter 102 to emit an infrared beam only when the pattern is recognized, (2) alter game play information stored on the microprocessor (such as increase user game health or amount of damage caused by the laser tag sword 100), or (3) both simultaneously. The microprocessor 110 can be configured to recognize any number of patterns of signals. The laser tag sword 100 may emit an infrared beam from the infrared emitter 102 without making contact with another player, but solely on information received from the accelerometer 106 and gyroscope 108.

In the method described herein, the laser tag sword 100, vest 200, and headset 300 may all communicate and transmit information to and from each device and among other swords 100, vests 200, and headsets 300 of other users. All devices may communicate with a central server. Each device may have infrared emitters and infrared receivers. The operations described herein may be performed by microprocessors on any device or the central server. The microprocessors compare signals from each accelerometer and each gyroscope to seek patterns of movement. Certain patterns of movement may result in changes in game play information or activation of the infrared emitters. In other embodiments, if users are together on a team, separate devices can be communicatively connected so that each member must perform a specific pattern of movement with the laser tag sword 100 to activate the infrared emitter 102 on each user's laser tag sword 100 or otherwise alter game play information stored on the microprocessors. The microprocessors can determine when a user successfully makes a specific movement with a laser tag sword by constantly measuring the signals received from the accelerometer and gyroscope and comparing the received signals to a predetermined series of signals stored in memory, or comparing the signals to previously received signals and determining the difference in motion, position, or displacement. The microprocessor may also compare changes in motion, position, or displacement to predetermined levels of changes of motion, position, or displacement. The system may then activate the infrared emitter, or alter stored gameplay data, based on the measure of change.

In other embodiments the laser tag sword 100 may be a standard handheld computerized device, such as a mobile cellular phone, which is utilized as a weapon or is alternatively placed within a foam handled structure to replicate a weapon.

The following disclosure also applies to the invention in question. In the following disclosure, the following definitions apply:
IR—Infrared Light, invisible to human eye, used for pulsed data transmission to an infrared sensor electronic device, later decoded by a microcontroller.
IMU—Inertial measurement unit is an electronic device that measures and reports a body's specific force, angular rate, and sometimes the magnetic field surrounding the body, using a combination of accelerometers 106 and gyroscopes 108, sometimes also magnetometers.
LED—light emitting diode
RFID—tagging is an ID system that uses small radio frequency identification devices for identification and tracking purposes. An RFID tagging system includes the tag itself, a read/write device, and a host system application for data collection, processing, and transmission.
GUI—graphical user interface, used to present visible information for end user
Sword—can refer to a variety of weaponry, such as a sword, axe, maul, mace, dagger, staff, in 1 handed or 2 handed variations. All have same electronics, but different enclosure.

The invention is directed to an electronic sword fighting with scoring. Swords, shields and melee devices that play sound on motion and will trigger electronic multiplayer scoring on physical striking of another player.

A user can equip multiple weapons that pair via bluetooth to a vest. The vest will detect hits from enemy weapons via IR sensing. The weapons will make sounds based on user motion gestures, such as a sword slashing through the air would make the sound of a real life blade cutting through the air, or a sword clashing against another blade would make a loud clink noise on impact. A variety of short range melee weapons and shields can be equipped, in one hand, both hands, or even toggling between even more weapons. If the player blocks a hit with a sword or shield, the sword/shield will send a command to the vest to have it ignore incoming IR data for a short period of time. Incoming IR hits are buffered in the vest for a short period of time to watch for incoming bluetooth commands from the sword or shield, which would be delayed behind the actual IR hit. If no block command arrives in time, the user will take a hit, which may result in a vibration, sound and/or LED effect. Upon successful hit of a sword against a vest, the player may hear an audible notification from the vest, such as a clink or a player scream. If the player runs out of health, the player may die, and be able to revive into the game in a variety of methods. The goal is to avoid taking direct hits to your vest, while deflecting projectiles and enemy sword blows with your own sword, and make direct hits against your enemy's vest, possibly multiple enemies at a time. The sword can also be thrown, which will trigger an IR pulse on hit.

A bow can also be added to the game, which would pair to the vest to create sound, thereby lowering the weight and size of the bow drastically. The bow will add ranged attacking to the game, which is a critical element in medieval style role-playing. The bow would reload with a quiver attachment which sockets into the vest, allowing the user to pull on a simulated arrow to reload the bow for the next shot. The sword can actively ‘deflect’ projectiles by slashing the blade upon receiving a hit from a ranged attack such as a bow hit. User will hear a notification sound effect, feel a vibration, see LED blink and/or see an indication on the phone GUI on hit, allowing the user to react within a fixed duration of time, to reflect or deflect the IR damage (either completely ignore or reflect damage back to sender or nearby enemy via star wars style). A single successful slash deflect could trigger a set deflection period, such as block a quick barrage of bullets with a single slash. The deflection can also drain user simulated stamina in software, causing a temporary exhaustion stun effect on players, to help balance out the deflection.

The vest can emit IR damage outward from player to simulate an explosion, or friendly aura, or a directional facing attack such as a melee attack. The vest can also indicate direction of attack, if bluetooth connected to a phone application for use as a heads up display and game scoring system.

The sword can encompass a variety of weaponry, such as a sword, axe, maul, mace, dagger, staff, in 1 handed or 2 handed variations. The shield can be a variety of shapes, but meant mostly for defense, though it can be pushed towards a user to trigger a defensive IR attack. The shield will trigger invulnerability if hit by a sword for a short period, while making a clink noise on impact, and protecting user from sword based IR attacks even if the vest saw said IR attack. The shield can also deflect IR pulses from ranges weapons such as bows and guns in similar fashion.

The vest acts as the sound effect machine for attached weaponry, and as the radio central hub. Shields/Swords/Bows/pistols/grenades all pair to the vest via bluetooth, and the vest will poll the radios for data periodically, then play sound effects and send IR pulses as needed. The vest may have a second radio for connection to a mobile phone to run applications used for scoring or GUI. The vest can also sense IR hits from weaponry, both ranged and melee, and process said information to determine status of player life/death.

The vest may contain an optional long range sub-ghz radio, used to perform wireless scoring if no mobile phone application is paired to the vest. Scoring may entail, which team is in the lead, points to win, game timer, objective status, start/stop games and kill or assist confirmations.

A staff variation of the sword would work the same, with the addition of additional IMU for spinning action, and a secondary IR emitter for long ranged attacks, such as a wizard fireball or healing ray. The sword/shield/vest/bow can all partner with our existing laser tag system, allowing for a full IR battle between melee and ranged players. Players could avoid ranged attacks with sword and shield deflections to close the distance on ranged enemies.

The system may utilize the following equipment during gameplay:
Sword/Vest Technical Overview
   Vest with IR sensors in multiple locations, such as shoulders, central back, central chest, and lower abdomen. Allows for hits from torso zone for player safety.
   Foam sword with narrow beam IR emitters mounted on hit or guard.
   Sword IR Emitters have adjustable range in hardware via toggling different resistances to lower power flow via mosfets. Range also controllable in software for fine tuning via pulse width modulation up/down and frequency shifting away from ideal sensor frequency.
   Sword reacts to a variety of motion gestures from the user: which will trigger sound effects, vibration and/or IR pulses
      Light/Medium/Heavy Slashes
      Thrusts
      Clash/Impact
      Twist
      Spin
      Inactivity
      Deflection
      Sheathe/Unsheathe (requires vest)
Sword
   2 IR emitters with narrow beam angle
   IMU—Gyroscope and accelerometer 106
   Mainboard with microcontroller and bluetooth
   microUSB port
   2-3 push buttons
   LED indicator light
   Power switch
   Battery
   Foam sword, nylon core rod and latex coating over blade
Shield
   One IR emitter with medium/narrow beam angle
   IMU—Gyroscope and accelerometer 106
   Mainboard with microcontroller and bluetooth
   microUSB port
   2-3 push buttons
   LED indicator light
   Power switch
   Battery
   Foam shield, nylon core rod and latex coating over blade
Vest
   5 sensor PCBs with 2 IR sensors each (6-10 total IR sensors)
   4 IR emitters
   Bluetooth
   Mainboard with microcontroller
   SD card
   Audio codec
   Speaker
   Hit vibration feedback
   4-6 Push buttons
   LED hit indicators
   Long range radio
   microUSB port
   Power Switch
   Battery
   Nylon or plastic vest covering shoulders, mid back, and mid chest area

Other embodiments of the invention are possible where the system may utilize the following:
Vest with impact sensing plates
   (IMU used to sense vibration impacts)
   IR pulse from sword or headset that would only process if vest sensed a vibration, must calibrate impact sensing to not false trigger from player motion
Vest with magnetic sensing plates
   Sword with magnets embedded in blade, the magnets either permanent magnets or electromagnets
   IR pulse from sword or headset that would only process if vest sense a magnetic field from a blade impact. The magnetic sensing plates may be any type of magnetic field sensor.
Vest with RFID reader
   Sword with RFID active or passive tags/antennas in blade
   Vest with RFID readers on multiplexor in multiple locations on vest
   Sword could tag vest with a hit if in proximity, combined with IR pulse from headset or sword to determine source of damage.
   Actively assisted RFID tag would allow for larger tagging radius (1 meter ideal)
   allowing for high accuracy and low collateral damage (indirect nearby player tagging), also if active, can send data on tag dynamically adjusting damage received etc.
Vest with capacitive touch sensing
   Sword with graphite infused silicone/rubber coating, to simulate a very large stylus.
   Vest covered with capacitive touch sensing conductive fabric.
   IR pulse from sword or headset that would only process if vest senses a capacitive touch in the correct intensity, such as from a sword hit, similar to a stylus on a touchpad. The vest may use any type of capacitive sensor. The capacitive sensor will change resistance as the laser tag sword approaches the sensing field. The system will only detect a hit when both the infrared signal is received and the resistance of the capacitive sensor is altered.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A computerized method for controlling the operation of a laser tag gaming weapon
a) wherein said laser tag gaming weapon comprises one or more microprocessors, one or more infrared emitters, and one or more accelerometers;
b) said method comprising
i) detecting an acceleration with said one or more accelerometers;
ii) generating, by said one or more accelerometers, an acceleration signal in response to said acceleration;
iii) receiving, by said one or more microprocessors, said acceleration signal;
iv) generating, by said one or more microprocessors, an emission signal in response to said acceleration signal;
v) transmitting, by said one or more microprocessors, said emission signal to one or more infrared emitters;
vi) receiving, by said one or more infrared emitters, said emission signal; and
vii) emitting, by said one or more infrared emitters, a first infrared beam in response to said emission signal.

2) The computerized method as in claim 1
a) wherein said laser tag gaming weapon further comprises one or more gyroscopes;
b) said method further comprising
i) detecting positional orientation of said laser tag gaming weapon by said one or more gyroscopes;
ii) generating, by said one or more gyroscopes, a positional signal; and
iii) receiving, by said one or more microprocessors, said positional signal.

3) The computerized method as in claim 2 further comprising
a) comparing, by said one or more microprocessors, said positional signal to predetermined positional information stored on said one or more microprocessors; and
b) altering, by said one or more microprocessors, game status data stored on said one or more microprocessors in response to said positional signal.

4) The computerized method as in claim 2 further comprising
a) comparing, by said one or more microprocessors, said positional signal to predetermined positional information stored on said one or more microprocessors; and
b) altering, by said one or more microprocessors, said emission signal in response to said positional signal.

5) The computerized method as in claim 1 further comprising determining, by said one or more microprocessors, an amount of force detected by said one or more accelerometers.

6) The computerized method as in claim 5 further comprising altering, by said one or microprocessors, said emission signal.

7) The computerized method as in claim 5 further comprising altering, by said one or more microprocessors, game status data stored on said one or more microprocessors in response to said amount of force detected by said one or more accelerometers.

8) The computerized method as in claim 1
a) wherein said microprocessor is communicatively coupled to one or more omnidirectional infrared receivers;
b) said method further comprising
i) detecting, by said one or more omnidirectional infrared receivers, a second infrared beam emitted by a second gaming device;
ii) generating, by said one or more omnidirectional infrared receivers, a hit signal in response to detecting said second infrared beam emitted by a second gaming device; and
iii) receiving, by said one or more microprocessors, said hit signal from said one or more omnidirectional infrared receivers.

9) The computerized method as in claim 8 further comprising determining, by said one or more microprocessors, a time differential between a generation of an emission signal and a receipt of a hit signal.

10) The computerized method as in claim 9 further comprising
a) comparing, by said one or more microprocessors, said time differential to a predetermined amount of time stored on said one or more microprocessors; and
b) generating, by said one or more microprocessors, a time comparison result.

11) The computerized method as in claim 10 further comprising altering, by said one or more microprocessors, game status data stored on said one or more microprocessors in response said time comparison result.

12) The computerized method as in claim 1 further comprising
a) detecting, by one or more vest omnidirectional infrared receivers integral to a gaming vest worn by an opposing player, said first infrared beam;
i) wherein said gaming vest further comprises one or more pressure sensitive plates and one or more vest microprocessors;
b) generating, by said one or more vest omnidirectional infrared receivers, a second hit signal;
c) receiving, by said one or more vest microprocessors, said second hit signal;
d) detecting, by said one or more pressure sensitive plates, physical impact;
e) generating, by said one or more pressure sensitive plates, an impact signal;
f) receiving, by said one or more vest microprocessors, said impact signal; and
g) altering, by said one or more vest microprocessors, game status data stored on said one or more vest microprocessors only when said one or more vest microprocessors receives both said second hit signal and said impact signal.

13) The computerized method as in claim 1 further comprising
a) detecting, by one or more vest omnidirectional infrared receivers integral to a gaming vest worn by an opposing player, said first infrared beam;
i) wherein said gaming vest further comprises one or more magnetic field sensors and one or more vest microprocessors;
ii) wherein said laser tag gaming weapon further comprises one or more magnets;
b) generating, by said one or more vest omnidirectional infrared receivers, a second hit signal;
c) receiving, by said one or more vest microprocessors, said second hit signal;
d) detecting, by said one or more magnetic field sensors, the presence of one or more magnets;
e) generating, by said one or more magnetic field sensors, a magnet signal;
f) receiving, by said one or more vest microprocessors, said magnet signal; and
g) altering, by said one or more vest microprocessors, game status data stored on said one or more vest microprocessors only when said one or more vest microprocessors receives both said second hit signal and said magnet signal.

14) The computerized method as in claim 1 further comprising
a) detecting, by one or more vest omnidirectional infrared receivers integral to a gaming vest worn by an opposing player, said first infrared beam;
i) wherein said gaming vest further comprises one or more vest RFID units and one or more vest microprocessors;
ii) wherein said laser tag gaming weapon further comprises one or more weapon RFID tags;
b) generating, by said one or more vest omnidirectional infrared receivers, a second hit signal;
c) receiving, by said one or more vest microprocessors, said second hit signal;
d) detecting, by said one or more vest RFID units, the presence of one or more weapon RFID tags;
e) generating, by said one or more vest RFID units, a tag signal;
f) receiving, by said one or more vest microprocessors, said tag signal; and
g) altering, by said one or more vest microprocessors, game status data stored on said one or more vest microprocessors only when said one or more vest microprocessors receives both said second hit signal and said tag signal.

15) The computerized method as in claim 1 further comprising
a) detecting, by one or more vest omnidirectional infrared receivers integral to a gaming vest worn by an opposing player, said first infrared beam;
i) wherein said gaming vest further comprises one or more capacitive sensors and one or more vest microprocessors;
b) generating, by said one or more vest omnidirectional infrared receivers, a second hit signal;
c) receiving, by said one or more vest microprocessors, said second hit signal;
d) detecting, by said one or more capacitive sensors, the presence of said laser tag weapon;
e) detecting, by said one or more vest microprocessors, a change in resistance of said one or more capacitive sensors; and
f) altering, by said one or more vest microprocessors, game status data stored on said one or more vest microprocessors only when said one or more vest microprocessors receives said second hit signal and detects a change in resistance of said one or more capacitive sensors.

16) A computerized method for controlling the operation of a laser tag gaming weapon
a) wherein said laser tag gaming weapon comprises one or more microprocessors, one or more infrared emitters, and one or more gyroscopes;
b) said method comprising
i) detecting positional orientation of said laser tag gaming weapon by said one or more gyroscopes;
ii) generating, by said one or more gyroscopes, a first positional signal;
iii) receiving, by said one or more microprocessors, said first positional signal; and
iv) altering, by said one or more microprocessors, game status data stored on said one or more microprocessors in response to said positional signal.

17) The computerized method as in claim 16 further comprising
a) generating, by said one or more gyroscopes, a second positional signal;
b) receiving, by said one or more microprocessors, said second positional signal; and
c) comparing, by said one or more microprocessors, said first positional signal to said second positional signal.

18) The computerized method as in claim 17 further comprising determining, by said one or more microprocessors, an amount of change between said first positional signal and said second positional signal.

19) The computerized method as in claim 18 further comprising
a) comparing, by said one or more microprocessors, said amount of change between said first positional signal and said second positional signal to a predetermined amount of change information stored on said one or more microprocessors; and
b) altering, by said one or more microprocessors, game status data stored on said one or more microprocessors when said amount of change between said first positional signal and said second positional signal is greater than said predetermined amount of change information.

20) The computerized method as in claim 16 further comprising comparing, by said one or more microprocessors, said first positional signal to predetermined positional information stored on said one or more microprocessors.
